(19) United States
(12) Patent Application Publication
(10) Pub. No.: US 2025/0297909 A1
(43) Pub. Date: Sep. 25, 2025

(54) ENVIRONMENTAL SENSOR AND METHOD FOR OPERATING AN ENVIRONMENTAL SENSOR

(71) Applicant: Robert Bosch GmbH, Stuttgart (DE)

(72) Inventors: Paul Fehling, Tuebingen (DE); Umidjon Nurmetov, Tuebingen (DE)

(21) Appl. No.: 19/081,131

(22) Filed: Mar. 17, 2025

(30) Foreign Application Priority Data
Mar. 25, 2024 (DE) 10 2024 202 829.0

(51) Int. Cl. G01L 9/12; G01L 27/00

(52) U.S. Cl. CPC G01L 9/12; G01L 27/007

(57) ABSTRACT

An environmental sensor. The environmental sensor includes: a MEMS element; an ASIC element which is electrically conductively connected to the MEMS element via at least two electrical conductors, in particular bonding wires. The ASIC element and/or a substrate on which the MEMS element and/or the ASIC element are arranged includes at least one further electrical conductor. The ASIC element includes an evaluation circuit connected to the further electrical conductor. The evaluation circuit is configured to ascertain and evaluate a parasitic capacitance of the further electrical conductor, in order to detect a material deposit on the environmental sensor.

### FIELD

The present invention relates to an environmental sensor. The present invention also relates to a method for operating an environmental sensor. The present invention further relates to a computer program product.

### BACKGROUND INFORMATION

Pressure sensors are exposed to the external environment, which is why liquids can come into contact with them. This can lead to offsets in pressure readings due to the increase in mass created by the presence of the liquid itself.

Self-tests are available for sensors in which a subsequent check of measured values is performed by means of an excitation of a MEMS element.

PCT Patent Application No. WO 2020/023414 A1 describes a method for liquid detection in a sensor environment and measures for removing the detected liquid. A capacitive water detection on a gel-filled sensor interior is disclosed.

U.S. Pat. No. 10,640,367 B2, and U.S. Patent Application Publication Nos. US 2004/0108861 A1 and US 2019/0383688 A1 describes sensors with capacitive electrodes with which deposited liquid droplets can be detected due to a changed dielectric constant of the environment.

U.S. Patent Application Publication No. US 2020/0064215 A1 combines the aforementioned approaches by detecting water using capacitors and employing heating elements in order to evaporate the water droplet after detection.

### SUMMARY

It is an object of the present invention to provide an improved environmental sensor.

According to a first aspect of the present invention, the object is achieved with an environmental sensor having certain features of the present invention. According to an example embodiment of the present invention, the environmental sensor includes:
a MEMS element;
an ASIC element, which is electrically conductively connected to the MEMS element via at least two electrical conductors, in particular bonding wires, wherein the ASIC element and/or a substrate on which the MEMS element and/or the ASIC element are arranged comprises at least one further electrical conductor, wherein the ASIC element comprises an evaluation circuit, wherein the evaluation circuit is connected to the further electrical conductor, wherein the evaluation circuit is designed to ascertain and evaluate a parasitic capacitance of the further electrical conductor, in order to detect a material deposit on the environmental sensor.

Depending on the chosen design, the substrate can also be omitted.

In the environmental sensor of the present invention, a parasitic capacitance can be ascertained by a capacitance measurement by means of the evaluation circuit of the ASIC element using at least one further electrical conductor electrically connected to the evaluation circuit, via which the presence of a material deposit can be detected.

Advantageously, existing further electrical conductors of the environmental sensor, in particular of the substrate and/or the ASIC element, can be used, as a result of which space and area can be saved. In this way, the presence of a material deposit, e.g., in the form of liquid, salt crust, etc., on the environmental sensor or on its MEMS element can be ascertained. This exploits a changing permittivity at the environmental sensor due to material deposition, which can be accompanied by a change in the parasitic capacitance. For example, evaluation software can be hard-wired into the ASIC element, which can be used to perform a self-test of the proposed environmental sensor in order to determine its functionality.

The object may achieved according to a second aspect of the present invention with a method for operating an environmental sensor, wherein the environmental sensor comprises a MEMS element and an ASIC element that is electrically connected to the MEMS element via at least two electrical conductors, wherein the ASIC element and/or a substrate on which the MEMS element and/or the ASIC element are arranged comprises at least one further electrical conductor. According to an example embodiment of the present invention, the method includes the following steps:
applying an electrical control signal to the further electrical conductor;
ascertaining a parasitic capacitance of the further electrical conductor;
evaluating the ascertained parasitic capacitance; and signaling a result of the evaluation.

The provided method of the present invention can be used in production or in the field, wherein in case of a failure the environmental sensor (e.g., an impact sensor in the automotive sector) is replaced in order to avoid consequential damage.

According to a third aspect of the present invention, the object may be achieved by a computer program product having program code means, configured for performing the method according to the present invention when it is run on an environmental sensor of the present invention or is stored on a computer-readable data carrier.

Advantageous developments of the environmental sensor according to the present invention and the method of the present invention are disclosed herein.

The MEMS element can comprise a sensor structure or sensor circuit. This could include, for example, a capacitive Wheatstone bridge circuit.

With regard to the evaluation performed by the evaluation circuit of the ASIC element, it is possible to detect the material deposit based on the parasitic capacitance ascertained at a point in time or based on an associated measured value and/or based on the parasitic capacitance ascertained over a time period or based on a plurality of associated measured values. The time period can be a specified time period. With reference to the latter variant, the detection of material deposition can be carried out on the basis of a change over time in the ascertained parasitic capacitance. For example, if a significant change in capacitance occurs within a relatively short time period, a material deposit can be recognized. In contrast, a change that occurs over a longer time period (for example, years), for example due to aging effects, cannot be classified as the presence of a material deposit.

In one example embodiment of the present invention, the ASIC element comprises at least one electrical shielding conductor, wherein the shielding conductor represents the further conductor. Thus, the shielding conductor, which can also be designed as a guard conductor, can be used for detecting the parasitic capacitance. Therefore, it is not necessary to provide a separate further electrical conductor. In addition, the length of the shielding conductor is relatively large, so that even small material deposits on the environmental sensor can be detected. The shielding conductor offers greater spatial coverage than individual additional electrodes and is also easier to manufacture.

In a further example embodiment of the present invention, the ASIC element comprises at least one second shielding conductor, wherein the second shielding conductor represents a second further conductor. The evaluation circuit is connected to the second further electrical conductor and the evaluation circuit of the ASIC element is designed to ascertain and evaluate a parasitic capacitance between the two shielding conductors in order to detect a material deposit on the environmental sensor. As a result, sensitivity in relation to recognizing material deposits is improved.

In a further example embodiment of the present invention, the substrate comprises at least one electrical ring conductor, wherein the ring conductor surrounds an area in which the ASIC element and/or the MEMS element are arranged on the substrate. The ring conductor represents the further electrical conductor, wherein the evaluation circuit of the ASIC element is designed to ascertain and evaluate a parasitic capacitance of the ring conductor in order to detect a material deposit on the environmental sensor. Thus, the sensitivity of recognizing the material deposit can be further improved.

In one example embodiment of the present invention, the substrate comprises at least one second electrical ring conductor, wherein the second ring conductor surrounds the ring conductor, wherein the second ring conductor represents a second further electrical conductor, wherein the evaluation circuit is connected to the second further electrical conductor, wherein the evaluation circuit of the ASIC element is designed to ascertain and evaluate a parasitic capacitance between the two ring conductors in order to detect a material deposit on the environmental sensor. This can also further improve the sensitivity of recognizing the material deposit.

A further advantageous development of the environmental sensor according the present invention provides that at least one further electrical conductor, in particular two further electrical conductors, are connected to a capacitive Wheatstone bridge circuit of the MEMS element. Here, the evaluation circuit is designed to ascertain the parasitic capacitance by means of a capacitance measurement relating to a reference capacitance of the capacitive Wheatstone bridge circuit.

In this configuration, a drive signal for the Wheatstone bridge circuit can be used to ascertain the parasitic capacitance. The drive signal can be generated by the evaluation circuit and applied to at least one of the two further electrical conductors for ascertaining the capacitance. Furthermore, it can be exploited that the parasitic capacitance, which can exist in particular between the two further electrical conductors, can be in the form of a capacitance connected in parallel to the reference capacitance of the bridge circuit. During the capacitance measurement performed by the evaluation circuit, a total capacitance can therefore be ascertained as the sum of the fixed reference capacitance and the parasitic capacitance, as a result of which conclusions can be drawn about the parasitic capacitance. Thus, ascertaining the total capacitance therefore represents ascertaining the parasitic capacitance. According to the above explanations, the material deposit can be detected based on the total capacitance ascertained at a point in time or based on an associated measured value and/or based on the total capacitance ascertained over a time period (i.e., a change in the same over time) or based on a plurality of associated measured values.

Further advantageous developments of the environmental sensor of the present invention provide that the bridge circuit is a full-bridge circuit or a half-bridge circuit.

A further advantageous development of the environmental sensor of the present invention provides that the evaluation circuit is designed to determine by means of a defined capacitance value that no material deposits whatsoever are present on the environmental sensor. This can be carried out based on a comparison of the ascertained parasitic capacitance or a corresponding measured value with the defined capacitance value. The defined capacitance value can be a previously known comparison value or threshold value.

The evaluation circuit can further be designed to perform a comparison using not only one but a plurality of different comparison or threshold values. These can refer to different materials. In this way, it is possible to recognize different material deposits.

A further advantageous development of the environmental sensor of the present invention provides that the environmental sensor further comprises a signaling device, by means of which the presence of a material deposit can be signaled. A user of the environmental sensor can thus easily recognize whether or not the environmental sensor is impaired in its proper functionality. The signaling device can be activated by the evaluation circuit of the ASIC element. The signaling can be carried out in an optical, acoustic and/or haptic manner, for example.

A further advantageous development of the environmental sensor of the present invention provides that the evaluation circuit is designed to activate a device for removing liquid when liquid is recognized. For example, in this case a heater, a fan or the like can be activated.

Further advantageous developments of the environmental sensor of the present invention provide that the environmental sensor is designed as a liquid sensor, pressure sensor, gas sensor, humidity sensor or microphone. Advantageously, the proposed environmental sensor can be implemented in a variety of forms.

With regard to the method of the present invention, signaling can be carried out in an optical, acoustic and/or haptic manner. For this purpose, a signaling device of the environmental sensor can be activated.

Furthermore, it is possible to perform the method of the present invention or at least the steps of applying the electrical control signal, ascertaining the parasitic capacitance and evaluating it at defined points in time and/or cyclically.

The present invention is described in detail below with further features and advantages based on a plurality of figures. The figures are primarily intended to illustrate the principles substantial to the present invention.

Other method features result analogously from corresponding other apparatus features, and vice versa. This means in particular that features, technical advantages and embodiments relating to the environmental sensor of the present invention result analogously from corresponding embodiments, features and advantages relating to the method of the present invention for operating an environmental sensor and vice versa.

### BRIEF DESCRIPTION OF THE DRAWINGS

FIG. 1 is a cross-sectional view of an embodiment of a proposed environmental sensor;

FIG. 2 is a cross-sectional view of an embodiment of a proposed environmental sensor with a highlighted detail view;

FIG. 3 is a basic circuit diagram of a first embodiment of a proposed environmental sensor;

FIG. 4 is a basic circuit diagram of a second embodiment of a proposed environmental sensor;

FIG. 5 is a basic circuit diagram of an embodiment of the ASIC element;

FIG. 6 is a schematic top view of a substrate having ring conductors;

FIG. 7 is a measurement diagram showing the occurrence of liquid on the environmental sensor; and

FIG. 8 is a sequence diagram over time having a basic sequence of a proposed method for operating an environmental sensor.

### DETAILED DESCRIPTION OF EXAMPLE EMBODIMENTS

The environmental sensor 100 of the present invention is explained in more detail below as a sensor having capacitive measuring sensors. The measured variable is detected on the basis of a MEMS element 10, in which both variable capacitances (active measuring elements) and reference capacitances are installed. In addition, the MEMS element 10 can be protected by either gel and/or oil.

A detection principle for detecting material deposits is proposed, in which the presence of a material deposit on the environmental sensor 100 is evaluated, wherein for this purpose a capacitance variation of a capacitance between bonding wires between the MEMS element 10 and the ASIC element 20 is ascertained and evaluated.

The following explains the detection of a material deposit in the form of liquid, in particular water. Advantageously, the method of the present invention can also be used for detecting other undesirable material deposits, such as particles, fibers, deposits, structures, biofilms, sweat, salt, etc. Therefore, this capacitance variation is measured based on the pressure measurement chain already implemented in the ASIC element 20.

An environmental sensor 100 is proposed, which can be designed, for example, as a barometric capacitive pressure sensor. In such a capacitive sensor, pressure is detected by means of a MEMS element 10, in which both variable capacitances (the actual pressure measuring elements) and fixed reference capacitances are installed, and which are arranged in a capacitive Wheatstone bridge circuit.

Advantageously, the proposed method does not require a dedicated signal processing chain, but the recognition of the material deposit can be achieved with a specific configuration of the ASIC element 20. In addition, the liquid detection is located closer to the gel surface, i.e., where a liquid deposit is expected and where sensor performance is most affected, than in previous implementations. Thus, this proposed concept is well able to detect and/or quantify material deposits, as a result of which appropriate countermeasures can be taken in case of detection.

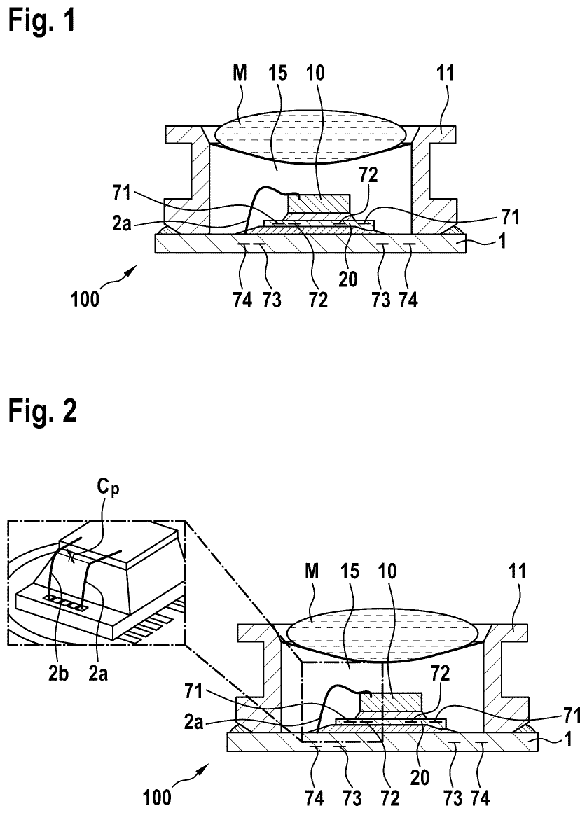

FIG. 1 is a cross-sectional view of an embodiment of a proposed environmental sensor 100. An ASIC element 20, with which a signal evaluation can be performed, can be seen on a substrate 1. A MEMS element 10 is arranged on the ASIC element 20. The ASIC element 20 and the MEMS element 10 can be implemented in the form of semiconductor components or semiconductor chips. The ASIC element 20 and the MEMS element 10 are electrically connected to one another by means of at least two bonding wires 2a, 2b, which are connected to contact surface or contact elements of the MEMS and ASIC elements 10, 20, referred to here as bond pads or pads. The environmental sensor 100 or the MEMS and ASIC elements 10, 20 are protected by a protective element 15 (e.g., gel). It can also be seen that a material deposit M, e.g., in the form of water, is located on the upper side of the protective element 15, which can impair the functionality of the environmental sensor 100. As the protective element 15, oil buffer solutions (used, for example, in high-pressure applications, e.g., industrial or automotive applications) or air-permeable membrane solutions (established for microphones/acoustic transducers) can also be used instead of gel. The environmental sensor 100 in the form of a capacitive pressure sensor is further covered by means of a cap element 11 (e.g., a metal cover) and is thus additionally protected.

In addition, the ASIC element 20 can comprise a first and/or second further electrical conductor 71, 72, which are designed, for example, as a shielding conductor and in particular represent guard conductors. Furthermore, the substrate 1 can comprise a third and/or fourth further electrical conductor 73, 74, which are designed in the form of ring conductors.

Other embodiments of the environmental sensor 100 with other arrangements of MEMS and ASIC elements 10, 20, not shown in the drawings, are also possible.

Due to the presence of water (or another deposited medium), a parasitic capacitance Cₚ changes between the first and/or the second further electrical conductor 71, 72 and/or between the third and/or the fourth further electrical conductor 73, 74, which is ascertained and evaluated, wherein on the basis of this evaluation it is concluded that water (or another medium) is present on the environmental sensor 100. In addition, due to the presence of water (or another deposited medium), a parasitic capacitance Cₚ can change between the first further electrical conductor 71 and one of the bonding wires and/or the second further electrical conductor 72 and one of the bonding wires and/or between the third further electrical conductor 73 and one of the bonding wires and/or the fourth further electrical conductor 74 and one of the bonding wires. The parasitic capacitance is ascertained and evaluated, wherein on the basis of this evaluation it can be concluded that water (or another medium) is present on the environmental sensor 100,

The specified parasitic capacitance Cₚ is formed between the first and/or the second further electrical conductor 71, 72 and/or between the third and/or the fourth further electrical conductor 73, 74, which are capacitively coupled to one another. The value of this capacitance Cₚ depends on the permittivity of the surrounding material. Water (and also other media) on the protective element 15 or even within the protective element 15 (if a medium is soluble in the protective element 15) can thus change the capacitance value of the parasitic capacitance Cₚ, which is exploited in the proposed method.

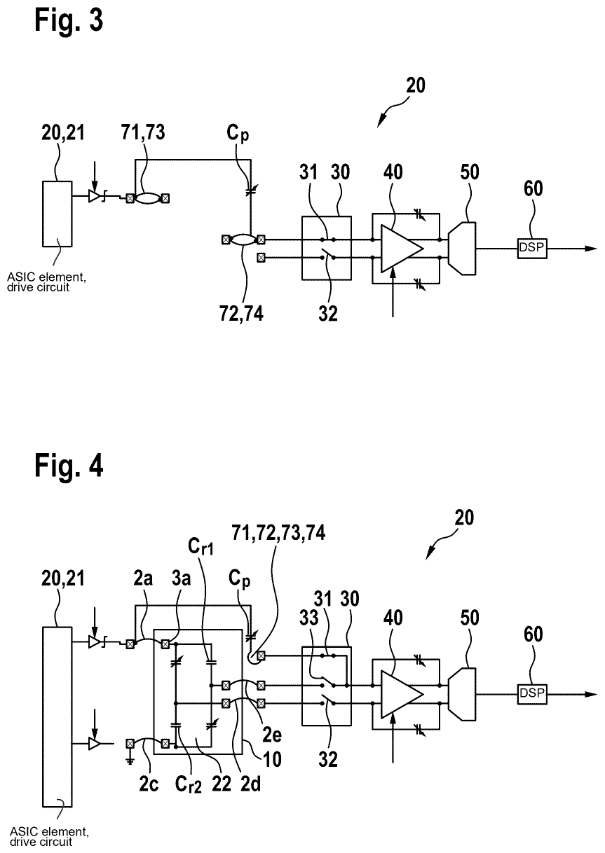

In a possible implementation of the proposed environmental sensor 100, as will be explained in more detail below with reference to FIG. 3, the first and/or the second further electrical conductor 71, 72 and/or the third and/or the fourth further electrical conductor 73, 74 are used, between which the parasitic capacitance Cₚ under consideration is formed. The first and/or the second further electrical conductor 71, 72 and/or the third and/or the fourth further electrical conductor 73, 74 are not functionally connected to the MEMS element 10. The capacitance present between the first and/or the second further electrical conductor 71, 72 and/or between the third and/or the fourth further electrical conductor 73, 74 can be read out by an analog front end of the ASIC element 20. In another implementation, there is only a first or second further electrical conductor 71, 72 or third or fourth further electrical conductor 73, 74, and the capacitance Cₚ under consideration is formed between the corresponding further electrical conductor and a bonding wire, which serves as a connection to the bridge circuit 22 or to a ground potential GND. This is explained in more detail below with reference to FIG. 4.

In this connection, for example, a defined or previously known capacitance value can be assumed at which there is no material deposit on the environmental sensor 100. If different capacitance values of the parasitic capacitance Cₚ are present, which can be ascertained based on the proposed measurement method, the presence of water, sweat, salt, or other materials on the environmental sensor 100 can be concluded.

This advantageously makes it possible to easily conclude that material is present on the environmental sensor 100, which may impair its functionality, and to subsequently activate, for example, an apparatus for removing the material deposits, such as a heater, a blower, etc. (not shown). Due to the removal of the material deposit M, the proper functionality of the environmental sensor 100 can thus be advantageously restored. However, it is also possible to signal (e.g., optically, acoustically, haptically) the presence of the material deposit M by activating a signaling device, so that a user can take the initiative to remove the material deposit M from the environmental sensor 100.

In the normal full-bridge circuit of the MEMS element 10, the changes in capacitance usually cancel one another out and/or cannot be distinguished from a pressure change and therefore cannot be recognized.

In the following, possible implementations of the proposed environmental sensor 100 are explained in more detail based on circuit diagrams.

FIG. 2 shows the environmental sensor 100 from FIG. 1 with a highlighted detail view.

In a first implementation of the environmental sensor 100 shown in FIG. 3, the first and/or the second further electrical conductor 71, 72 and/or the third and/or the fourth further electrical conductor 73, 74 are used, between which the parasitic capacitance Cₚ has been formed. The first and/or the second further electrical conductor 71, 72 and/or the third and/or the fourth further electrical conductor 73, 74 are connected to the evaluation circuit 20, 21. The capacitance Cₚ to be ascertained between the first and/or the second further electrical conductor 71, 72 and/or between the third and/or the fourth further electrical conductor 73, 74 can be read out, e.g., by an analog front end of the ASIC element 20.

In the proposed method for operating the environmental sensor 100, an electrical control signal is applied to the first further electrical conductor 71 and/or to the third further electrical conductor 73 by means of a drive circuit 21. The first and/or the second further electrical conductor 71, 72 and/or the third and/or the fourth further electrical conductor 73, 74 are capacitively coupled to one another, so that the parasitic capacitance Cₚ exists between two further electrical conductors.

A switch device 30 having a switch element 31 can be seen, which is electrically connected to the second further electrical conductor 72 and/or to the fourth further electrical conductor 74 and has been set to a closed switching state for measuring the parasitic capacitance Cₚ. In this way, an electrical signal relating to the capacitance Cₚ to be ascertained can be transmitted through the switch element 31 to an amplification device 40 (e.g., a low noise amplifier) and subsequently to an A/D converter 50 (analog-to-digital converter, ADC). By means of a subsequent digital signal processor 60 (DSP: digital signal processor), a capacitance value of the parasitic capacitance Cₚ can be ascertained from the signal. The functionality of such a signal processing chain is conventional and will therefore not be explained in detail here. The switch device 30, the amplification device 40, the A/D converter 50 and the digital signal processor 60, which are electrically connected to one another in a suitable manner, are, as is the drive circuit 21, components of the ASIC element 20.

Further configurations of the environmental sensor 100 are described below. Matching features along with components that are the same and have the same effect are not described in detail again in the following. For details on this, reference is made instead to the above description. Furthermore, aspects and details mentioned in relation to one configuration can also be applied in relation to another configuration and features of two or more configurations can be combined with one another.

In a further embodiment of the environmental sensor 100 shown in FIG. 4, there is only a first and/or second further electrical conductor 71, 72 and/or third and/or fourth further electrical conductor 73, 74, which is connected to the switch element 31 of the evaluation circuit 20. Here, the parasitic capacitance Cₚ to be ascertained is present between the connected first and/or second and/or third and/or fourth further electrical conductors 71, 72, 73, 74 and a first bonding wire 2a. The first bonding wire 2a serves as a connection to the capacitive Wheatstone bridge circuit 22 of the MEMS element 10 and is connected to a pad 3a connected to the bridge circuit 22. The pad 3a forms a connection pad of the bridge circuit 22. In this variant, the bonding wire 2a can advantageously be used as an electrical control conductor for the Wheatstone bridge circuit 22. It can be seen that in this case, switch elements 32, 33 of the switch device 30 are open, via which, in normal operation, capacitance values of the capacitive Wheatstone bridge circuit 22 are read out via bonding wires 2d, 2e for the purpose of pressure measurement. The bonding wires 2d, 2e are connected to further connection pads of the bridge circuit 22.

In the variants described here, barometric pressure is measured by means of the MEMS element 10, by implementing a fully capacitive bridge circuit in the form of the Wheatstone bridge circuit 22. Two elements of the bridge circuit 22 are variable capacitances and are used for pressure measurement. The other two elements are fixed capacitances Cᵣ₁, Cᵣ₂, which are used as reference capacitances. MEMS and ASIC elements 10, 20 are electrically connected to one another by a plurality of bonding wires 2a . . . 2e, which connect the ASIC element 20 and its drive circuit 21 to the bridge circuit 22. An electrical control signal is applied by means of the drive circuit 21 of the ASIC element 20.

In the embodiment shown in FIG. 4, according to FIG. 3, for the purpose of ascertaining the parasitic capacitance Cₚ, the switch element 31 of the switch device 30 connected to the connected first and/or second and/or third and/or fourth further electrical conductor 71, 72, 73, 74 is closed. As a result, if an electrical control signal is applied to the first bonding wire 2a via the drive circuit 21, an electrical signal relating to the parasitic capacitance Cₚ is transmitted through the switch element 31 to the signal processing chain, which comprises the amplification device 40, the A/D converter 50 and the digital signal processor 60. The digital signal processor 60 can thereupon provide a capacitance value of the capacitance Cₚ.

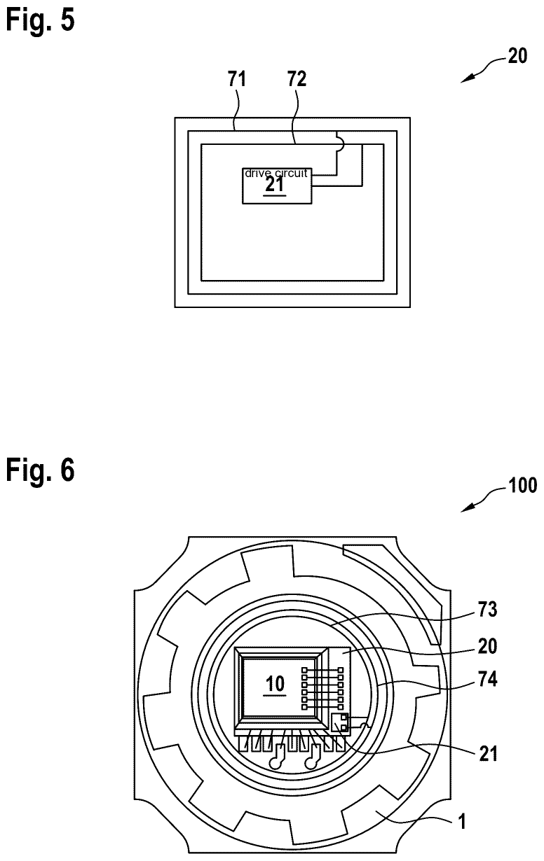

FIG. 5 shows a schematic representation of the ASCIC element 20 of FIGS. 1 and 2 having the evaluation circuit 21, which is connected to a first and a second further electrical conductor 71, 72, wherein the first and/or the second further electrical conductor 71, 72 are arranged in the ASIC element 20 and are designed in particular as separate electrical shielding conductors, which are designed, for example, circumferentially and as closed ring conductors. The shielding conductors 71, 72 are preferably arranged in an edge region of the ASIC element 20. The shielding conductors 71, 72 represent, for example, guard conductors of the ASIC element 20.

FIG. 6 shows a schematic representation of a top view of a further embodiment of the environmental sensor 100, wherein the MEMS element 10 and the ASIC element 20 are arranged on the substrate 1. The MEMS element 10 and the ASIC element 20 can also be arranged one above the other as in FIG. 1, wherein the ASIC element 20 is arranged on the substrate 1. The ASIC element 20 can be designed according to FIG. 5.

A third and fourth further electrical conductor 73, 74 in the form of ring conductors are formed in the substrate. The ring conductors surround an area on which the MEMS element 10 and the ASIC element 20 are arranged. In addition, the third and fourth further electrical conductors 73, 74 are connected to the evaluation circuit 21, as was explained schematically in FIGS. 3 and 4, for example.

The detection of a material deposit M on the environmental sensor 100 can be carried out based on a measured value of the parasitic capacitance Cₚ. For example, a comparison can be carried out with a defined or previously known capacitance value at which there is no material deposit M on the environmental sensor 100. Additionally or alternatively, it is possible to detect a material deposit M based on the parasitic capacitance Cₚ ascertained over a time period, and therefore to perform the same based on a plurality of measured values. In case a significant change in capacitance occurs in a relatively short time period, a material deposit M can be recognized.

An evaluation as described above can be performed by the digital signal processor 60 of the ASIC element 20. If the signal processor 60 detects the presence of a material deposit M in this way, the signal processor 60 can then activate, for example, a signaling device for signaling the determined material deposit M and/or an apparatus for removing the material deposit (not shown).

The detection of a material deposit M by a change in capacitance over time is explained in more detail below. In this sense, a material deposit can be ascertained by measuring the total capacitance C using the following formula:

$$C ( t ) = {C}_{r 1} + {C}_{p} ( t ) \qquad ( 2 )$$

where:
C . . . total capacitance
Cᵣ₁ . . . fixed reference capacitance of the Wheatstone bridge circuit
Cₚ . . . parasitic capacitance
t . . . time

For detecting the material deposit M, it is sufficient to recognize a change in the measured total capacitance C, wherein a significant change in the total capacitance C ascertained within a defined short time allows a conclusion to be drawn about a corresponding change in the parasitic capacitance Cₚ due to a material deposit M. A detected change in the total capacitance C can be directly (for example, linearly) associated with a change in the parasitic capacitance Cₚ due to a material deposit M. Defined numerical values can be ascertained during calibration measurements at the end of production and can take into account numerous circumstances (e.g., sensor model, batches, material properties, etc.).

This applies at least to individual measurements at defined points in time within a sufficiently short time period (e.g., days, weeks, months), so that aging effects (e.g., drifts) over longer periods of time (e.g., years) can advantageously not influence the measurements, so that material deposits are not detected unintentionally and incorrectly. For example, a value of the total capacitance C can be defined at which no material deposit is present on the environmental sensor 100, wherein subsequent measured values can be compared with this defined value of the total capacitance C in order to determine whether or not a material deposit M is now present on the environmental sensor 100.

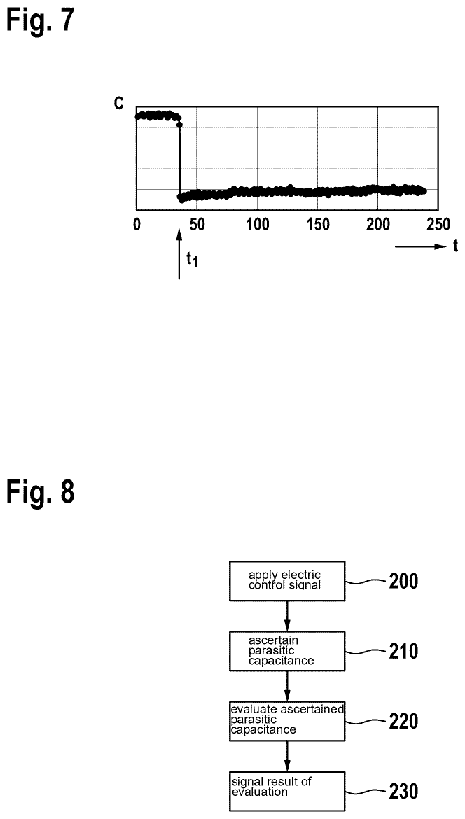

FIG. 7 shows, purely qualitatively, a change in the total capacitance C if at a point in time ti, a water droplet is placed on the protective element 15 of the environmental sensor 100. This is associated with a significant change in the parasitic capacitance Cₚ and thus the total capacitance C, and can therefore be reliably recognized based on a corresponding capacitance measurement.

The proposed detection principle also applies in general to embodiments that differ from those mentioned above. Furthermore, the proposed method can also be applied to capacitive pressure sensors in a half-bridge configuration (not shown), i.e., in which only one fixed and one variable capacitance are implemented.

FIG. 8 shows a flowchart of a method for operating the proposed environmental sensor 100.

In a step 200, an electrical control signal is applied to the first and/or the second further electrical conductor 71, 72 and/or the third and/or the fourth further electrical conductor 73, 74, wherein the first and/or the second and/or the third and/or the fourth further electrical conductor 71, 72, 73, 74 are capacitively coupled to one another, so that a parasitic capacitance Cₚ exists between two further electrical conductors.

In a step 210, a parasitic capacitance Cₚ formed between at least two further electrical conductors is ascertained. In addition, a further electrical conductor between the at least one further electrical conductor supplied with the control signal and one of the bonding wires, in particular the Wheatstone bridge, can also be ascertained.

In a step 220, the ascertained parasitic capacitance Cₚ is evaluated.

In a step 230, a result of the evaluation is signaled.

The proposed method can be carried out, e.g., in the form of a self-test during production tests, in order to sort out faulty environmental sensors 100. It could optionally also be carried out later in the field in order to recognize faults during the service life of the environmental sensor 100. In this case, a comparison value/threshold value can be stored in the production unit in a non-volatile memory. The comparison value/threshold value represents a capacitance value at which no material deposits whatsoever are present on the environmental sensor 100. Comparison or threshold values can preferably be ascertained for different materials, so that different material deposits can be easily recognized using different comparison or threshold values.

The proposed method can preferably be designed as software executed at least partially on the ASIC element 20 or at least partially externally therefrom, as a result of which easy adaptability of the method is supported. Alternatively, the proposed method can be implemented at least partially or completely in hardware.

Advantageously, the proposed method can be implemented as a computer program that runs on the ASIC element 20 of the environmental sensor 100 or is stored on a computer-readable data carrier.

In summary, the present invention proposes an environmental sensor 100 and a method for operating an environmental sensor 100, with which a test for the presence of a material deposit M is easily possible, as a result of which a status of the environmental sensor 100 and a permissibility of measuring processes can be advantageously assessed.

A person skilled in the art will suitably modify and/or combine the features of the present invention without departing from the essence of the present invention.

1-14. (canceled)

15. An environmental sensor, comprising:
a MEMS element; and
an ASIC element, which is connected to the MEMS element via at least two electrical conductors, wherein the ASIC element and/or a substrate on which the MEMS element and/or the ASIC element are arranged, includes at least one further electrical conductor, wherein the ASIC element includes an evaluation circuit, wherein the evaluation circuit is connected to the further electrical conductor, wherein the evaluation circuit is configured to ascertain and evaluate a parasitic capacitance of the further electrical conductor, to detect a material deposit on the environmental sensor.

16. The environmental sensor according to claim 15, wherein the ASIC element includes at least one electrical shielding conductor, wherein the shielding conductor represents the further conductor.

17. The environmental sensor according to claim 16, wherein the ASIC element includes at least one second shielding conductor, wherein the second shielding conductor represents a second further conductor, wherein the evaluation circuit is connected to the second further electrical conductor, wherein the evaluation circuit of the ASIC element is configured to ascertain and evaluate a parasitic capacitance between the two shielding conductors, to detect a material deposit on the environmental sensor.

18. The environmental sensor according to claim 15, wherein the substrate includes at least one electrical ring conductor, wherein the ring conductor surrounds an area in which the ASIC element and/or the MEMS element are arranged on the substrate, wherein the ring conductor represents the further electrical conductor, wherein the evaluation circuit of the ASIC element is configured to ascertain and evaluate a parasitic capacitance of the ring conductor, to detect a material deposit on the environmental sensor.

19. The environmental sensor according to claim 18, wherein the substrate includes at least one second electrical ring conductor, wherein the second ring conductor surrounds the ring conductor, wherein the second ring conductor represents a second further electrical conductor, wherein the evaluation circuit is connected to the second further electrical conductor, wherein the evaluation circuit of the ASIC element is configured to ascertain and evaluate a parasitic capacitance between the ring conductor and the second ring conductors, to detect a material deposit on the environmental sensor.

20. The environmental sensor according to claim 15, wherein at least one of the further electrical conductor is connected to a capacitive Wheatstone bridge circuit of the MEMS element, and wherein the evaluation circuit is configured to ascertain a parasitic capacitance of the at least one further electrical conductor using a capacitance measurement relating to a reference capacitance of the capacitive Wheatstone bridge circuit.

21. The environmental sensor according to claim 20, wherein the bridge circuit is a full-bridge circuit or a half-bridge circuit.

22. The environmental sensor according to claim 15, wherein the evaluation circuit is configured to determine using a defined capacitance value that no material deposits are present on the environmental sensor.

23. The environmental sensor according to claim 15, wherein the environmental sensor further comprises a signaling device, using which the presence of a material deposit can be signaled.

24. The environmental sensor according to claim 15, wherein the evaluation circuit is configured to activate a device for removing liquid when liquid is recognized.

25. The environmental sensor according to claim 15, wherein the environmental sensor is at least one of the following: liquid sensor, pressure sensor, gas sensor, humidity sensor, microphone.

26. A method for operating an environmental sensor, the environmental sensor including a MEMS element, and an ASIC element that is electrically connected to the MEMS element via at least two electrical conductors, wherein the ASIC element and/or a substrate on which the MEMS element and/or the ASIC element are arranged includes at least one further electrical conductor, the method comprising the following steps:
applying an electrical control signal to the further electrical conductor;
ascertaining a parasitic capacitance of the further electrical conductor;
evaluating the ascertained parasitic capacitance; and
signaling a result of the evaluation.

27. The method according to claim 26, wherein at least the steps of applying the electrical control signal, ascertaining the parasitic capacitance and evaluating the ascertained capacitance are performed at defined points in time and/or cyclically.

28. A non-transitory computer-readable data carrier on which is stored a computer program with program code for operating an environmental sensor, the environmental sensor including a MEMS element, and an ASIC element that is electrically connected to the MEMS element via at least two electrical conductors, wherein the ASIC element and/or a substrate on which the MEMS element and/or the ASIC element are arranged includes at least one further electrical conductor, the program code, when executed by the ASIC element, causing the ASIC element to perform the following steps:
applying an electrical control signal to the further electrical conductor;
ascertaining a parasitic capacitance of the further electrical conductor;
evaluating the ascertained parasitic capacitance; and
signaling a result of the evaluation.
